(19) United States
(12) Patent Application Publication
(10) Pub. No.: US 2004/0032490 A1
(43) Pub. Date: Feb. 19, 2004

(54) Image sensing apparatus, image sensing method, program, and storage medium

(76) Inventor: Mineo Uchida, Kanagawa (JP)

Correspondence Address: MORGAN & FINNEGAN, L.L.P., 345 PARK AVENUE, NEW YORK, NY, 10154, US

(21) Appl. No.: 10/439,766

(22) Filed: May 16, 2003

Related U.S. Application Data
(63) Continuation of application No. 09/867,355, filed on May 29, 2001, now Pat. No. 6,580,451.

(30) Foreign Application Priority Data
May 17, 2002 (JP) 2002-143136 (PAT.

(51) Int. Cl. H04N 5/253; H04N 9/47

(52) U.S. Cl. 348/96; 348/265

(57) ABSTRACT

If photographing conditions such as the ISO speed or shutter speed or environmental conditions such as the ambient temperature require no dark image data during photography, an AF operation and AE operation are performed when a shutter switch SW1 is pressed, and photography is performed when a shutter switch SW2 is pressed after that, without performing any dark loading, in both single shot photography and continuous photography. In development, horizontal dark shading correction is performed using one-dimensional correction data. This one-dimensional correction data of one horizontal line for use in the horizontal dark shading correction is formed by performing a projective arithmetic operation for an image which is obtained by dark photography and stored in a nonvolatile memory 56 in a production process.

### FIELD OF THE INVENTION

The present invention relates to an image sensing apparatus, image sensing method, program, and storage medium for sensing, recording, and playing back still images, motion images, and the like.

### BACKGROUND OF THE INVENTION

As an image sensing apparatus of this type, an image sensing apparatus such as a digital camera which uses a memory card having a solid-state memory device as a recording medium and records and plays back still images and motion images sensed by a solid-state image sensor such as a CCD or CMOS has been conventionally put on the market.

By selecting a photography mode of this digital camera, it is possible to switch single shot photography by which photography is performed frame by frame whenever a shutter button is pressed, and continuous photography by which photography is continuously performed while the shutter button is kept pressed.

Also, when image sensing is performed by using a solid-state image sensor such as a CCD or CMOS, dark noise correction can be performed by an arithmetic operation by using dark image data which is read out after electric charge is stored in the same manner as in regular photography while the image sensor is not exposed, and regular photography image data which is read out after electric charge is stored while the image sensor is exposed.

By this dark noise correction, a high-quality image can be obtained by correcting image quality deterioration, such as dark current noise produced in the image sensor or pixel loss caused by a very small flaw unique to the image sensor, of photographed image data.

Since dark current noise increases in accordance with the charge storage time and the temperature rise of the image sensor, a large image quality improving effect can be obtained especially when exposure is performed for a long time or at a high temperature. Therefore, this dark noise correction is a useful function for the user of a digital camera.

When regular photography is performed after dark image data is photographed by the conventional image sensing apparatus such as a digital camera described above, photographing frame intervals can be made equal during continuous photography. However, during single shot photography, a shutter release time lag increases by the dark image photographing time, so the user may miss a precious shutter chance.

On the other hand, when dark image data is photographed after regular photography is performed, a shutter release time lag can be decreased during single shot photography. However, during continuous photography, the photographing interval between the first and second frames increases, so the photographing frame intervals cannot be made equal.

In addition, photographing conditions and environmental conditions for long-time exposure or high-temperature exposure are not taken into consideration at all. That is, circuit system noise exists in addition to image quality deterioration such as dark current noise produced in the image sensor or pixel loss caused by a very small flaw unique to the image sensor. This circuit system noise is not taken into consideration at all. The circuit system noise is fixed-pattern noise which is dark offset produced by, e.g., voltage fluctuations caused by the resistance component of a power line in the sensor or sensor variations.

### SUMMARY OF THE INVENTION

As an image sensing apparatus capable of preventing image quality deterioration while minimizing the number of times of dark image photography which causes a shutter release time lag, the present invention is an image sensing apparatus for recording a photographed image on a recording medium comprising image sensing means capable of image sensing in a first image sensing mode in which first image data is obtained by performing image sensing in a non-exposed state, and a second image sensing mode in which second image data is obtained by performing image sensing in an exposed state, correction data storage means for storing correction data for correcting the second image data obtained in the second image sensing mode which is obtained by an arithmetic operation on the basis of the first image data, selecting means for selecting one of the first image data obtained in the first image sensing mode and the stored correction data, and correcting means for correcting the second image data obtained in the second image sensing mode by using the selected first image data or correction data.

An image sensing method of the present invention is an image sensing method of recording a photographed image on a recording medium comprising a first image sensing step of obtaining first image data by performing image sensing in a non-exposed state, a second image sensing step of obtaining second image data by performing image sensing in an exposed state, a correction data storage step of storing correction data for correcting the second image data which is obtained by an arithmetic operation on the basis of the first image data, a selection step of selecting one of the obtained first image data and the stored correction data, and a correction step of correcting the obtained second image data by using the selected first image data or correction data.

Other features and advantages of the present invention will be apparent from the following description taken in conjunction with the accompanying drawings, in which like reference characters designate the same or similar parts throughout the figures thereof.

### BRIEF DESCRIPTION OF THE DRAWINGS

The accompanying drawings, which are incorporated in and constitute a part of the specification, illustrate embodiments of the invention and, together with the description, serve to explain the principles of the invention.

FIG. 1 is a block diagram showing the arrangement of a digital camera according to an embodiment;

FIG. 2 is a view showing mixing of fixed-pattern noise in the horizontal and vertical directions;

FIG. 3 is a flow chart showing the photographing operation procedure of an image processor 100;

FIG. 4 is a flow chart continued from FIG. 3 to show the photographing operation procedure of the image processor 100;

FIG. 5 is a flow chart continued from FIGS. 3 and 4 to show the photographing operation procedure of the image processor 100;

FIG. 6 is a view showing original image correction performed by black data subtraction or horizontal dark shading correction;

FIG. 7 is a flow chart showing a focusing/photometry procedure in step S114;

FIG. 8 is a flow chart showing a photographing procedure in step S128;

FIG. 9 is a flow chart continued to FIG. 8 to show the photographing procedure in step S128;

FIG. 10 is a flow chart showing a dark loading procedure in steps S121 and S131;

FIGS. 11A and 11B are views showing the flow of the photographing operation of this embodiment; and

FIG. 12 is a view showing original image correction using one-dimensional data in both the vertical and horizontal directions.

### DETAILED DESCRIPTION OF THE PREFERRED EMBODIMENT

Preferred embodiments of the present invention will now be described in detail in accordance with the accompanying drawings.

An image sensing apparatus, image sensing method, program, and storage medium according to an embodiment of the present invention will be explained with reference to the accompanying drawings. The image sensing apparatus of this embodiment is applied to a digital camera.

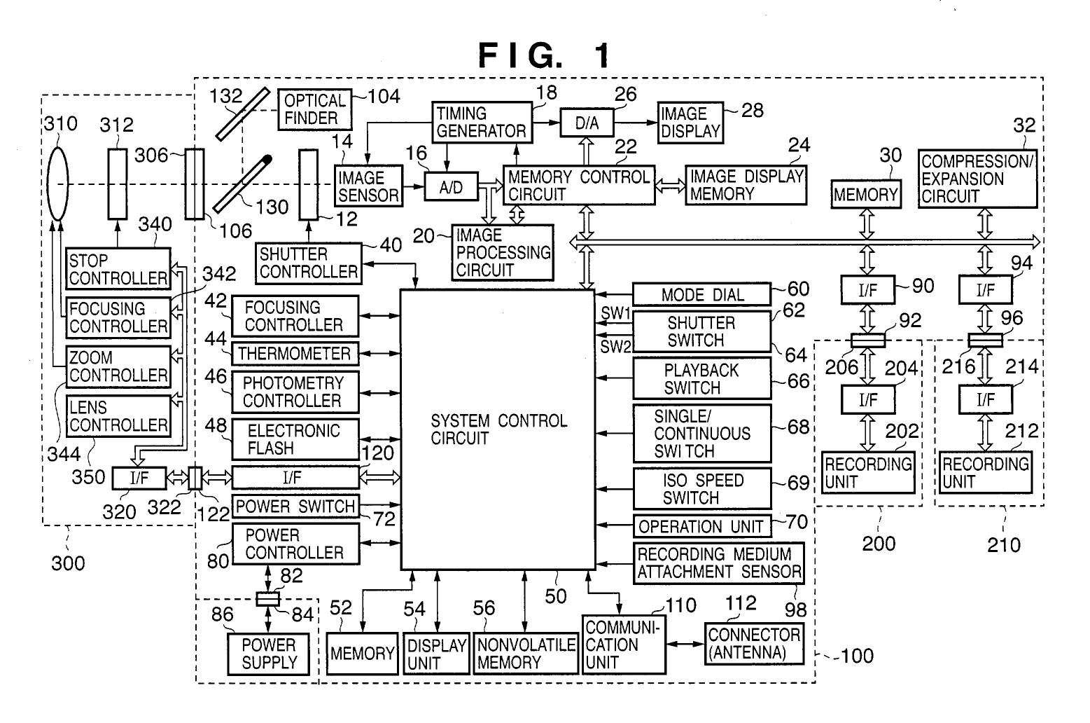

FIG. 1 is a block diagram showing the arrangement of the digital camera according to the embodiment. In FIG. 1, reference numeral 100 denotes an image processor; 12, a shutter having a stop function of controlling the exposure amount of an image sensor 14; and 14, the image sensor which converts an optical image into an electrical signal.

Light entering a photographing lens 310 in a lens unit 300 forms an optical image on the image sensor 14 through a stop 312, lens mounts 306 and 106, a mirror 130, and the shutter 12 by the single-lens reflex system.

An A/D converter 16 converts an output analog signal from the image sensor 14 into a digital signal. A timing generator 18 supplies clock signals and control signals to the image sensor 14, the A/D converter 16, and a D/A converter 26. The timing generator 18 is controlled by a memory control circuit 22 and system control circuit 50.

An image processing circuit 20 performs predetermined pixel interpolation or color conversion for data from the A/D converter 16 or data from the memory control circuit 22. The image processing circuit 20 performs a predetermined arithmetic operation by using sensed image data as needed. On the basis of the obtained operation result, the system control circuit 50 performs a TTL (Through-The-Lens) AF (Auto-Focusing) process, AE (Automatic Exposure) process, and EF (Electronic Flash light control) process to control an exposure (shutter) controller 40 and focusing controller 342. Also, the image processing circuit 20 performs a predetermined arithmetic operation by using sensed image data and, on the basis of the obtained operation result, performs TTL AWB (Automatic White Balance) processing.

This embodiment includes the focusing controller 342 and a photometry controller 46 as dedicated units. Therefore, the system control circuit 50 can perform the AF (Auto-Focusing) process, AE (Automatic Exposure) process, and EF (Electronic Flash light control) process by using the focusing controller 42 and photometry controller 46, but need not perform the AF (Auto-Focusing) process, AE (Automatic Exposure) process, and EF (Electronic Flash light control) process by using the image processing circuit 20.

Alternatively, the system control circuit 50 can perform the AF (Auto-Focusing) process, AE (Automatic Exposure) process, and EF (Electronic Flash light control) process by using the focusing controller 42 and photometry controller 46, and can also perform the AF (Auto-Focusing) process, AE (Automatic Exposure) process, and EF (Electronic Flash light control) process by using the image processing circuit 20.

The memory control circuit 22 controls the A/D converter 16, the timing generator 18, the image processing circuit 20, an image display memory 24, the D/A converter 26, a memory 30, and a compression/expansion circuit 32.

Data from the A/D converter 16 is written in the image display memory 24 or memory 30 via the image processing circuit 20 and memory control circuit 22 or via the memory control circuit 22 alone.

Reference numeral 24 denotes the image display memory; 26, the D/A converter; and 28, an image display which is a TFT LCD. Display image data written in the image display memory 24 is displayed on the image display 28 via the D/A converter 26. When sensed image data is sequentially displayed on the image display 28, a digital finder function can be realized. It is also possible to freely turn on and off the image display 28 in accordance with instructions from the system control circuit 50. When the image display 28 is turned off, the power consumption of the image processor 100 can be greatly reduced.

The memory 30 stores photographed still images or motion images, and has an enough memory capacity to store a predetermined number of still images or a predetermined time of motion images. Accordingly, even in continuous photography or panorama photography during which a plurality of still images are continuously photographed, a large amount of images can be written in the memory 30 at a high speed. The memory 30 can also be used as a work area of the system control circuit 50.

The compression/expansion circuit 32 compresses and expands image data by adaptive discrete cosine transform (ADCT) or the like. That is, the compression/expansion circuit 32 loads an image stored in the memory 30, compresses or expands the loaded image, and writes the processed data in the memory 30.

The shutter controller 40 controls the shutter 12 in collaboration with a stop controller 340 which controls the stop 312 on the basis of photometry information from the photometry controller 46. The focusing controller 42 performs the AF (Auto-Focusing) process. That is, the focusing controller 42 allows light entering the photographing lens 310 in the lens unit 300 to propagate through the stop 312, the lens mounts 306 and 106, the mirror 130, and a focusing submirror (not shown) by a single-lens reflex system, thereby measuring the focusing state of an image formed as an optical image.

A thermometer 44 detects the ambient temperature of a photographing environment. When this thermometer is installed in the image sensor 14, the dark current of the sensor can be predicted more accurately.

The photometry controller 46 performs the AE (Automatic Exposure) process. That is, the photometry controller 46 allows light entering the photographing lens 310 in the lens unit 300 to propagate through the stop 312, lens mounts 306 and 106, mirror 130, and focusing submirror (not shown) by the single-lens reflex system, thereby measuring the exposure state of an image formed as an optical image. The photometry controller 46 also achieves an EF (Electronic Flash light control) function in collaboration with an electronic flash 48. The electronic flash 48 has an AF auxiliary light emitting function and electronic flash light control function.

As described earlier, on the basis of the result of an arithmetic operation performed by the image processing circuit 20 by using image data sensed by the image sensor 14, the system control circuit 50 can perform exposure control and AF (Auto-Focusing) control using the video TTL system for the exposure (shutter) controller 40, the stop controller 340, and a focusing controller 342.

AF (Auto-Focusing) control may also be performed by using the measurement result obtained by the focusing controller 42 and the operation result obtained by the image processing circuit 20 by using image data sensed by the image sensor 14. Furthermore, exposure control may also be performed by using the measurement result obtained by the photometry controller 46 and the operation result obtained by the image processing circuit 20 by using image data sensed by the image sensor 14.

The system control circuit 50 controls the whole image processor 100 and incorporates a well-known CPU and the like. A memory 52 stores constants, variables, programs, and the like for operations of the system control circuit 50. A display unit 54 displays operating states, messages, and the like by using, e.g., characters, images, and sounds in accordance with execution of programs by the system control circuit 50. The display unit 54 has a liquid crystal display device, loudspeaker, and the like. The display unit 54 is installed in one or a plurality of places near an operation unit of the image processor 100, where the display unit 54 is easy to see. The display unit 54 is formed by combining an LCD, LEDs, sound generator, and the like. Some functions of the display unit 54 are installed in an optical finder 104.

Of the display contents of the display unit 54, those displayed on the LCD are, e.g., single shot/continuous photography indication, self-timer indication, the compression ratio, the number of recording pixels, the number of recorded frames, the number of remaining photographable frames, the shutter speed, the aperture value, exposure compensation indication, electronic flash indication, red-eye relief indication, macro photography indication, buzzer setting indication, the remaining amount of clock battery, the remaining amount of battery, error indication, information indication by a number of a plurality of digits, the state of attachment/detachment of recording media 200 and 210, the state of attachment/detachment of the lens unit 300, communication I/F operation indication, the date and time, and the state of connection to an external computer.

Of the display contents of the display unit 54, those displayed in the optical finder 104 are, e.g., in-focus indication, the completion of photography preparation, a camera shake warning, flash charge indication, the completion of flash charge, the shutter speed, the aperture value, exposure compensation indication, and recording medium write operation indication.

Of the display contents of the display unit 54, those indicated by the LED and the like are, e.g., in-focus indication, the completion of photography preparation, a camera shake warning, flash charge indication, the completion of flash charge, recording medium write operation indication, macro photography setting notification, and secondary battery charge indication.

Of the display contents of the display unit 54, an example indicated by a lamp or the like is a self-timer notification lamp. This self-timer notification lamp may also be the AF auxiliary light.

Reference numeral 56 denotes an electrically erasable/recordable nonvolatile memory storing programs (to be described later). An EEPROM is used as this nonvolatile memory. The nonvolatile memory 56 stores set values such as various parameters and the ISO speed, set modes, and one-dimensional correction data used for horizontal dark shading correction. This one-dimensional correction data is formed and written during adjustment in the production process. For example, the one-dimensional data can be data of one horizontal line formed by performing a projective arithmetic operation for an image obtained by dark photography.

The correction data may also be two-dimensional data obtained by directly storing a dark image sensed in the production process. However, vertical fixed-pattern noise is small in some image sensors, so only horizontal correction need only be performed in these sensors.

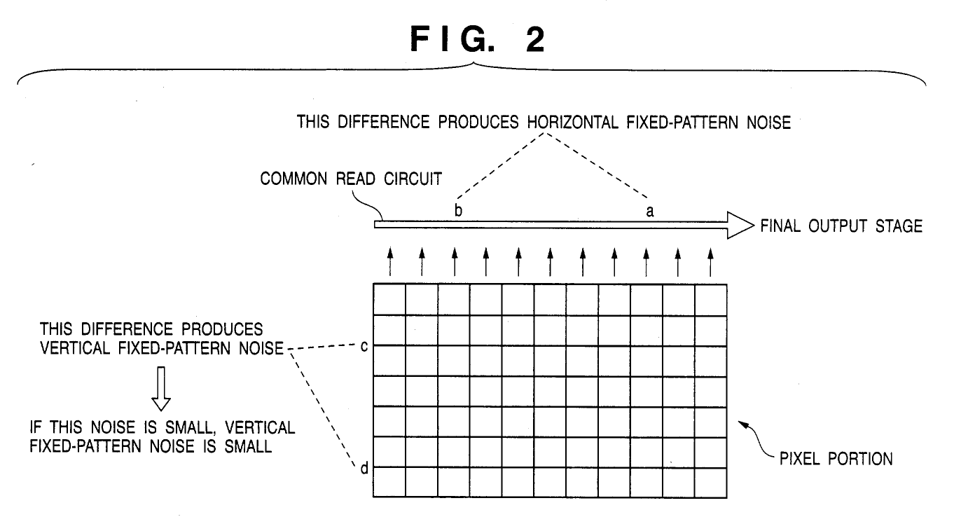

Fixed-pattern noise is often produced by a difference (variation) between read paths through which signals from pixels reach the final output stage when these signals are read out from a circuit system of the image sensor. FIG. 2 is a view showing mixing of fixed-pattern noise in the horizontal and vertical directions. Referring to FIG. 2, the horizontal fixed-pattern noise depends upon the difference between the read path of a vertical line a and the read path of a vertical line b. Likewise, the vertical fixed-pattern noise depends upon the difference between the read path of a horizontal line c and the read path of a horizontal line d. For example, as shown in FIG. 2, when an image sensor is so formed that horizontal lines share a read circuit and that noise mixed when a signal from each horizontal line is transferred to the common read circuit is reduced by, e.g., improving the circuit layout, the vertical fixed-pattern noise is small and hence need not be corrected. In an image sensing apparatus using this image sensor, fixed-pattern noise can be removed by correcting an original image by using horizontal one-dimensional correction data.

Reference numerals 60, 62, 64, 66, 68, and 70 denote operation units for designating various operations of the system control circuit 50. Each operation unit is, e.g., a switch, a dial, a touch panel, a pointing device using a visual axis, a voice recognition device, or a combination of a plurality of these devices. Details of these operation units will be described below.

A mode dial switch 60 can selectively set various functional photography modes such as an automatic photograph mode, program photography mode, shutter speed priority photography mode, aperture priority photography mode, manual photography mode, focal depth priority (depth) photography mode, portrait photography mode, landscape photography mode, close-up photography mode, sports photography mode, night view photography mode, and panorama photography mode.

A shutter switch (SW1) 62 is turned on in the middle of the operation of a shutter button (not shown) to start the operation of AF (Auto-Focusing), AE (Automatic Exposure), AWB (Automatic White Balance), EF (Electronic Flash light control), or the like.

A shutter switch (SW2) 64 is turned on when the operation of the shutter button (not shown) is complete. The shutter switch (SW2) 64 starts the operation of a series of processes, i.e., an exposure process in which a signal read out from the image sensor 14 is written as image data in the memory 30 via the A/D converter 16 and memory control circuit 22, a development process which uses arithmetic operations in the image processing circuit 20 and memory control circuit 22, and a recording process in which image data is read out from the memory 30, compressed by the compression/expansion circuit 32, and written in the recording medium 200 or 210.

A playback switch 66 starts a playback operation by which an image photographed in a photography mode is read out from the memory 30 or the recording medium 200 or 210 and displayed on the image display 28.

A single/continuous switch 68 can set a single shot mode in which a standby state is set after one frame is photographed when the shutter switch SW2 is pressed, and a continuous shooting mode in which photography is continuously performed while the shutter switch SW2 is kept pressed.

An ISO speed set switch 69 can set the ISO speed by changing the gain setting in the image sensor 14 or image processing circuit 20.

An operation unit 70 includes various buttons and a touch panel. Examples are a menu button, a set button, a macro button, a multiscreen playback page turning button, a flash set button, a single/continuous/self-timer switching button, a menu move +(plus) button, a menu move −(minus) button, a playback image move +(plus) button, a playback image move −(minus) button, a photographing image quality select button, an exposure compensation button, a date/time set button, a select/switch button for selecting and switching various functions when, e.g., panorama mode photography and playback are executed, a determine/execute button for determining and executing various functions when, e.g., panorama mode photography and playback are executed, an image display ON/OFF switch for setting ON/OFF of the image display 28, a quick review ON/OFF switch for setting a quick review function for automatically playing back photographed image data immediately after the photography, a compression mode switch for selecting the compression ratio of JPEG compression or for selecting a CCDRAW mode in which a signal from the image sensor is directly converted into a digital signal and recorded on the recording medium, a playback switch capable of setting various modes such as a playback mode, multiscreen playback/erase mode, and PC connection mode, and an AF mode set switch capable of setting a one-shot AF mode in which an auto-focusing operation is started when the shutter switch S1 is pressed and, once an in-focus state is obtained, this in-focus state is held, and a servo AF mode in which the auto-focusing operation is continued while the shutter switch SW1 is kept pressed.

The functions and numerical values of the plus buttons and minus buttons described above can be selected more smoothly by using rotary dial switches.

A power switch 72 can switch power ON and power OFF modes of the image processor 100. The power switch 72 can also switch power ON and power OFF settings of various devices such as the lens unit 300, an external strobe, and the recording media 200 and 210 connected to the image processor 100.

Reference numeral 80 denotes a power controller which includes a battery detection circuit, a DC-DC converter, a switching circuit for switching blocks to be powered on, and the like. The power controller 80 detects the presence/absence of a battery, the type of battery, and the battery remaining amount. On the basis of the detection results and instructions from the system control circuit 50, the power controller 80 controls the DC-DC converter to supply a necessary voltage to individual units including the recording media for a necessary period.

Reference numerals 82 and 84 denote connectors; and 86, a power supply which is a primary battery such as an alkaline battery or lithium battery, a secondary battery such as a NiCd battery, NiMH battery, or Li battery, or an AC adapter.

Reference numerals 90 and 94 denote interfaces with recording media such as memory cards or hard disks; 92 and 96, connectors for connecting to the recording media such as memory cards or hard disks; and 98, a recording medium attachment sensor for sensing whether the recording media 200 and 210 are attached to the connectors 92 and 96, respectively.

This embodiment includes two systems of interfaces and connectors for attaching recording media. However, it is also possible to install one or any arbitrary number of systems of interfaces and connectors for attaching recording media. In addition, as an interface and connector of another standard, those based on the standard of, e.g., a PCMCIA card or CF (Compact Flash (registered trademark)) card may also be used.

Furthermore, when the interfaces 90 and 94 and connectors 92 and 96 are based on the standard of, e.g., a PCMCIA card or CF (Compact Flash (registered trademark)) card, various communication cards such as a LAN card, modem card, USB card, IEEE1394 card, P1284 card, SCSI card, and PHS can be connected. Consequently, image data and management information attached to the image data can be transferred to another computer or a peripheral device such as a printer.

The optical finder 104 can guide light entering the photographing lens 310 through the stop 312, the lens mounts 306 and 106, the mirror 130, and a mirror 132 by the single-lens reflex system, and form an optical image of the light. Accordingly, photography can be performed using only the optical finder 104 without using the digital finder function of the image display 28. The optical finder 104 displays some functions of the display unit 54. Examples are in-focus indication, a camera shake warning, flash charge indication, the shutter speed, the aperture value, and exposure compensation indication.

A communication unit 110 has various communication functions such as RS232C, USB, IEEEE1394, P1284, SCSI, a modem, a LAN, and radio communication. Reference numeral 112 denotes a connector for connecting the image processor 100 to another apparatus via the communication unit 110, or an antenna for performing radio communication.

An interface 120 connects the image processor 100 to the lens unit 300 in the lens mount 106. A connector 122 electrically connects the image processor 100 to the lens unit 300. A lens attachment sensor 124 senses whether the lens unit 300 is attached to the lens mount 106 and/or the connector 122.

The connector 122 exchanges control signals, state signals, data signals, and the like between the image processor 100 and lens unit 300, and supplies electric currents having various voltages. The connector 122 may also perform optical communication and audio communication in addition to electrical communication.

The mirrors 130 and 132 guide light entering the photographing lens 310 to the optical finder 104 by the single-lens reflex system. The mirror 132 can be either a quick return mirror or half mirror.

The recording medium 200 is, e.g., a memory card or hard disk. The recording medium 200 has a recording unit 202 such as a semiconductor memory or magnetic disk, an interface 204 which interfaces with the image processor 100, and a connector 206 which connects to the image processor 100. Similar to the recording medium 200, the recording medium 210 is also a memory card, hard disk, or the like. The recording medium 210 has a recording unit 212 such as a semiconductor memory or magnetic disk, an interface 214 which interfaces with the image processor 100, and a connector 216 which connects to the image processor 100.

The lens unit 300 is an interchangeable lens unit. The lens mount 306 mechanically couples the lens unit 300 with the image processor 100. The lens mount 306 includes various functions of electrically connecting the lens unit 300 to the image processor 100.

Reference numeral 310 denotes the photographing lens; 312, the stop; 320, an interface for connecting the lens unit 300 to the image processor 100 in the lens mount 306; and 322, a connector for electrically connecting the lens unit 300 to the image processor 100.

The connector 322 exchanges control signals, state signals, data signals, and the like between the image processor 100 and lens unit 300, and also has a function of receiving and supplying various electric currents. The connector 322 may also transmit an optical signal, audio signal, and the like in addition to an electrical signal.

The stop controller 340 controls the stop 312 in collaboration with the shutter controller 40 which controls the shutter 12, on the basis of photometry information from the photometry controller 46. The focusing controller 342 controls focusing of the photographing lens 310. A zoom controller 344 controls zooming of the photographing lens 310. A lens system control circuit 350 controls the whole lens unit 300. The lens system control circuit 350 also has the function of a memory for storing constants, variables, programs, and the like for operations, and the function of a nonvolatile memory for holding identification information such as a number unique to the lens unit 300, management information, function information such as the open aperture value, minimum aperture value, and focal length, and present and past set values.

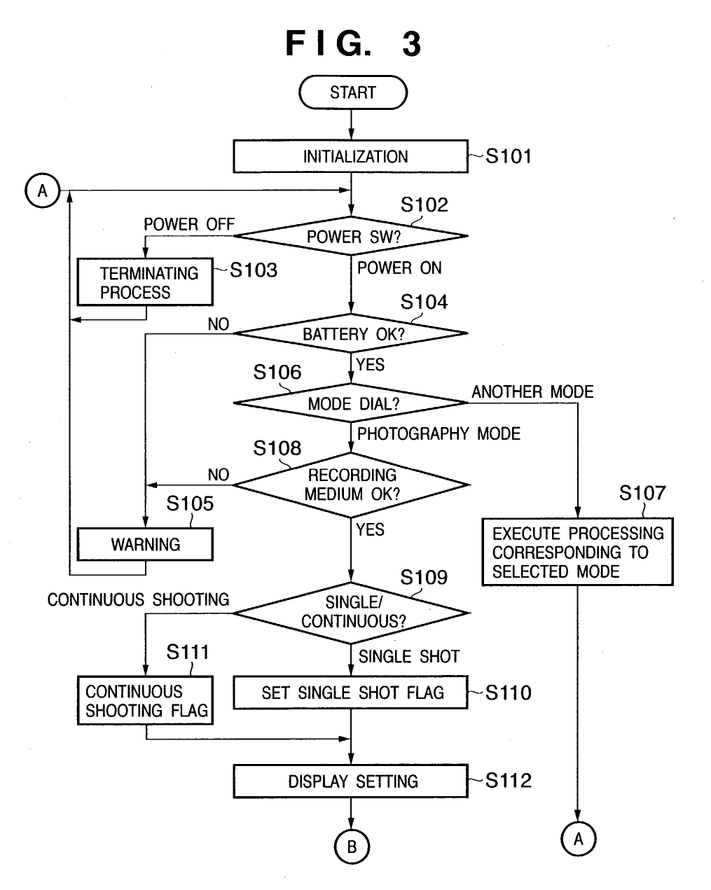

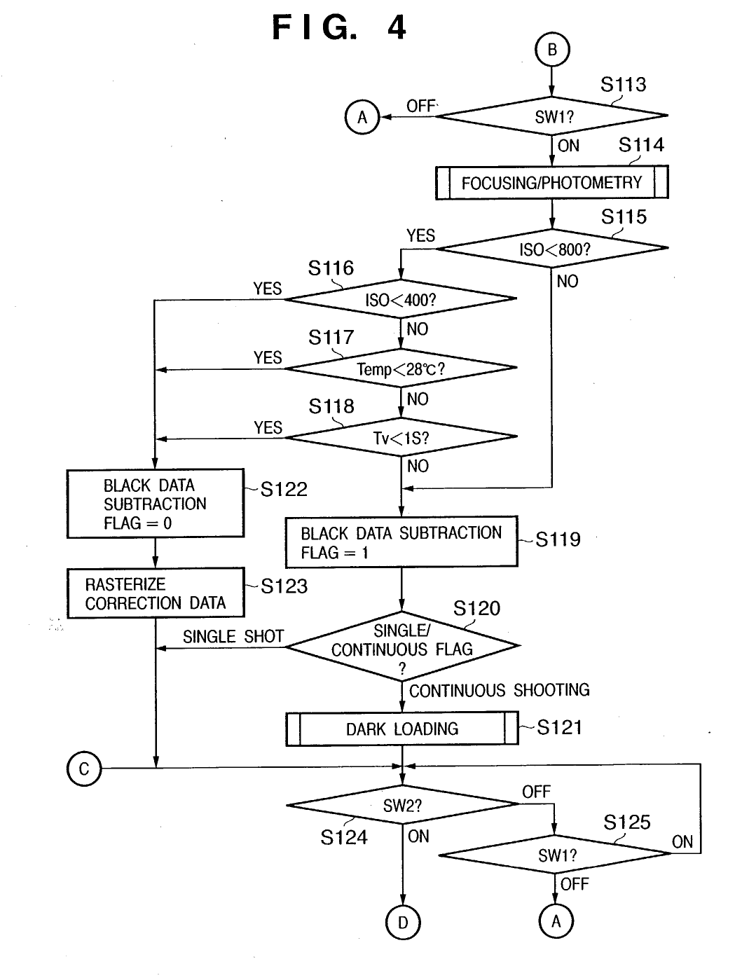

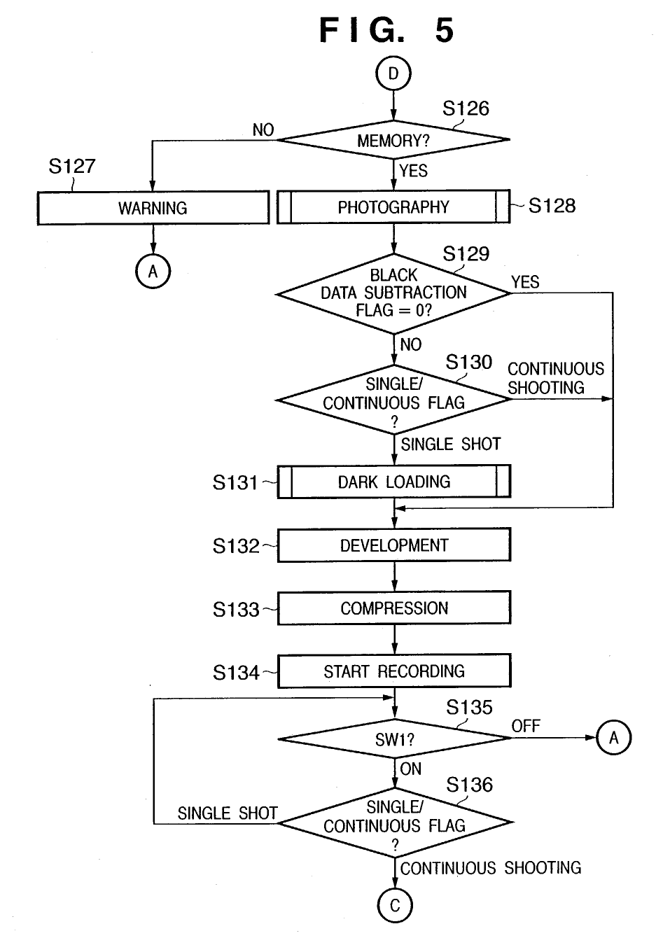

The operation of the digital camera having the above arrangement will be described below. FIGS. 3, 4, and 5 are flow charts showing the photographing operation procedure of the image processor 100. This processing program is stored in a storage medium such as the nonvolatile memory 30, loaded into the memory 52, and executed by the CPU of the system control circuit 50.

When the power supply is turned on such as when the battery is replaced, the system control circuit 50 initializes flags, control variables, and the like, and performs necessary predetermined settings for the individual units of the image processor 100 (step S101). The system controller 50 checks the set position of the power switch 72 to determine whether the power switch 72 is set to power OFF (step S102).

If the power switch 72 is set to power OFF, the system control circuit 50 performs predetermined termination processes, e.g., terminates the display of each display unit, records necessary parameters including flags and control variables, set values, and set modes in the nonvolatile memory 56, and causes the power controller 80 to shut down unnecessary power supply to the units including the image display 28 of the image processor 100 (step S103). After that, the flow returns to step S102.

If the power switch 72 is set to power ON, the system control circuit 50 causes the power controller 80 to check whether the remaining amount of the power supply 86 such as a battery and the operation status of the power supply 86 are suitable for the operation of the image processor 100 (step S104). If there is a problem, the system control circuit 50 gives a predetermined warning by displaying an image on the display unit 54 or outputting a sound (step S105), and the flow returns to step S102.

If the power supply 86 has no problem, the system control circuit 50 checks the set position of the mode dial switch 60 to determine whether the mode dial switch 60 is set to a photography mode (step S106). If the mode dial switch 60 is set to another mode, the system control circuit 50 executes processing corresponding to the selected mode (step S107), and the flow returns to step S102 after the execution.

If the mode dial switch 60 is set to the photography mode, the system control circuit 50 checks whether the recording medium 200 or 210 is attached, acquires management information of image data recorded in the recording medium 200 or 210, and checks whether the operating state of the recording medium 200 or 210 is suitable for the operation of the image processor 100, particularly, for recording and playback of image data with respect to the recording medium (step S108). If there is a problem, the system control circuit 50 gives a predetermined warning by displaying an image on the display unit 54 or outputting a sound (step S105), and the flow returns to step S102.

If there is no problem in step S108, the system control circuit 50 checks the selected state of the single/continuous switch 68 for selecting single shot photography/continuous photography (step S109). If single shot photography is selected, the system control circuit 50 sets the single/continuous flag to “single shot” (step S110). If continuous photography is selected, the system control circuit 50 sets the single/continuous flag to “continuous shooting” (step S111). The single/continuous switch 68 can freely switch a single shot mode in which a standby state begins after one frame is photographed when the shutter switch SW2 is pressed, and a continuous shooting mode in which photography is continuously performed while the shutter switch SW2 is kept pressed. Note that the state of the single/continuous flag is stored in an internal memory of the system control circuit 50 or in the memory 52.

The system control circuit 50 uses the display unit 54 to display various set states of the image processor 100 by images and sounds (step S112). If the image display switch of the image display 28 is ON, various set states of the image processor 100 may also be displayed by images and sounds by using the image display 28.

The system control circuit 50 checks whether the shutter switch SW1 is pressed (step S113). If the shutter switch SW1 is not pressed, the flow returns to step S102. If the shutter switch SW1 is pressed, the system control circuit 50 performs a focusing/photometry process, i.e., focuses the photographing lens 310 on an object and determines an aperture value and shutter speed (step S114). In the photometry process, the electronic flash is set if necessary. Details of this focusing/photometry process will be explained later.

After that, the system control circuit 50 checks the set speed of the camera. That is, the system control circuit 50 checks whether the set speed of the ISO speed set switch 69 is less than ISO800 (step S115). This check is performed because if the set speed is ISO800 or more, an exposure amount becomes small, so the image quality is significantly deteriorated by, e.g., dark current noise produced in the image sensor or by pixel loss caused by a very small flaw unique to the image sensor. Although the threshold value is ISO800 in this embodiment, it is of course also possible to set ISO1600. If the set speed is ISO800 or more, the flow advances to step S119. If the set speed is less than ISO800, the system control circuit 50 further checks whether the set speed is less than ISO400 (step S116).

If the set speed is less than ISO400, the flow advances to step S122. If the set speed is ISO400 or more, the system control circuit 50 checks whether an ambient temperature Temp measured by the thermometer 44 is less than 28° C. (step S117). If the ambient temperature Temp is less than 28° C., the flow advances to step S122. If the ambient temperature Temp is 28° C. or more, the system control circuit 50 checks whether a shutter speed Tv is less than 1 sec (step S118). If the shutter speed Tv is less than 1 sec, the flow advances to step S122. If the shutter speed Tv is 1 sec or more, the flow advances to step S119.

In the condition determination processes in steps S116, S117, and S118, ISO400, 28° C., and 1 sec are respectively set as threshold values. However, depending on the characteristics of the image sensor 14, some appropriate values may also be set.

Dark current noise increases with the charge storage time or with the temperature rise of the image sensor. Therefore, when long-time exposure or high-temperature exposure is to be performed, correction cannot be well performed by prestored correction data, so correction must be performed by black data subtraction.

Accordingly, if none of the conditions in steps S116 to S118 is met, the system control circuit 50 sets a black data subtraction flag to 1 (step S119). The system control circuit 50 then checks the set state of the single/continuous flag (step S120). If single shot is set, dark loading is performed after regular photography is completed, so the flow immediately advances to step S124. If continuous shooting is set, the system control circuit 50 performs dark loading for black data subtraction (step S121), and then the flow advances to step S124. By performing a correcting arithmetic operation by using dark image data loaded by this dark loading process, image quality deterioration, such as dark current noise produced in the image sensor 14 or pixel loss caused by a flaw unique to the image sensor 14, of photographed image data can be corrected. This dark loading process will be described later.

If any of the conditions in steps S116 to S118 is met, the system control circuit 50 clears the black data subtraction flag to 0 (step S122) and rasterizes correction data (step S123), in order to perform horizontal dark shading correction without any black data subtraction. Note that the state of the black data subtraction flag is stored in the internal memory of the system control circuit 50 or in the memory 52.

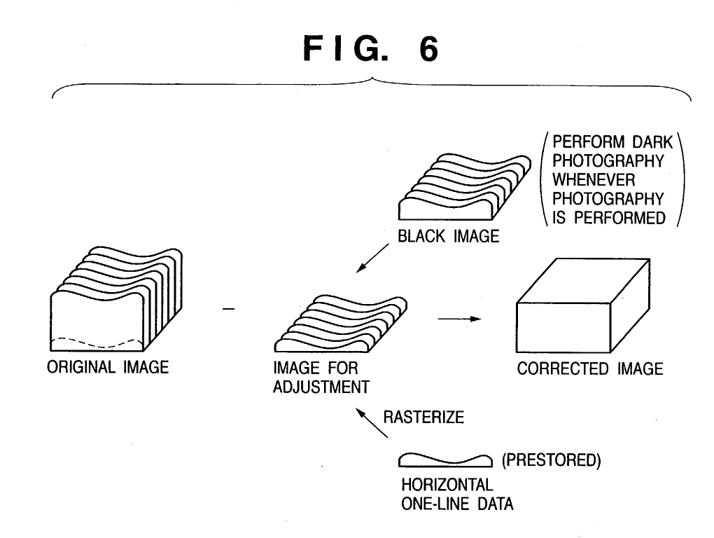

In step S123, the system control circuit 50 reads out one-dimensional correction data for use in horizontal dark shading correction from the nonvolatile memory 56, and repetitively rasterizes this one-dimensional data in the vertical direction by the same number of lines as an actual image in a predetermined region of the memory 30. After this correction data rasterization is completed, the flow advances to step S124. FIG. 6 is a view showing original image correction performed by black data subtraction or the horizontal dark shading correction data.

The system control circuit 50 checks whether the shutter switch SW2 is pressed (step S124). If the shutter switch SW2 is not pressed, the system control circuit 50 checks whether the shutter switch SW1 is released (step S125). The system control circuit 50 repeats the processes in steps S124 and S125 until the shutter switch SW1 is released or the shutter switch SW2 is pressed. If the shutter switch SW1 is released in step S125, the flow returns to step S102.

If the shutter switch SW2 is pressed in step S124, the system control circuit 50 checks whether the memory 30 has an image storage buffer area capable of storing the photographed image data (step S126). If the image storage buffer area of the memory 30 has no area capable of storing new image data, the system control circuit 50 performs a predetermined warning by displaying an image on the display unit 54 or outputting a sound (step S127), and the flow returns to step S102.

For example, this happens immediately after the maximum number of frames storable in the image storage buffer area of the memory 30 are continuously photographed, the first image to be read out from the memory 30 and written in the recording medium 200 or 210 has not been recorded in the recording medium 200 or 210, so an empty area for even one frame cannot be secured in the image storage buffer area of the memory 30.

When photographed image data is to be stored in the image storage buffer area of the memory 30 after being compressed, the compressed image data amount depends upon the settings of the compression mode. By taking this into consideration, therefore, the system control circuit 50 checks in step S126 whether there is a storage area in the image storage buffer area of the memory 30.

If determining in step S126 that the memory 30 has an image storage buffer area capable of storing the photographed image data, the system control circuit 50 executes a photographing process, i.e., reads out a sensed image signal stored for a predetermined time after image sensing from the image sensor 14, and writes the photographed image data in a predetermined area of the memory 30 via the A/D converter 15, image processing circuit 20, and memory control circuit 22, or from the A/D converter 16 via the memory control circuit 22 alone (step S128). Details of this photographing process will be described later.

When completing the photographing process in step S128, the system control circuit 50 checks the state of the black data subtraction flag stored in the internal memory or the memory 52 (step S129). If the black data subtraction flag is not set to 1, the flow advances to step S132. If the black data subtraction flag is set to 1, the system control circuit 50 checks the state of the single/continuous flag stored in the internal memory or the memory 52 (step S130). If continuous shooting is set, the flow advances to step S132.

As described above, when continuous shooting is set in step S130, a development process is executed (step S132) without performing a dark loading process in step S131 because dark loading is already performed in step S121 before execution of continuous photography. In this manner, continuous shooting frame intervals can be made substantially equal.

If single shot is set in step S130, the system control circuit 50 performs the dark loading process, i.e., stores noise components such as the dark current of the image sensor 14 for the same time as regular photography with the shutter 12 closed, and reads out the stored noise image signal (step S131). After that, the flow advances to step S132.

The system control circuit 50 reads out a portion of the image data written in the predetermined area of the memory 30, performs a WB (White Balance) integral operation and OB (Optical Black) integral operation necessary to perform development, and stores the operation results in the internal memory of the system control circuit 50 or in the memory 52.

The system control circuit 50 reads out the photographed image data written in the predetermined area of the memory 30 by using the memory control circuit 22 and, if necessary, the image processing circuit 20, and performs various development processes including AWB (Automatic White Balance), gamma conversion, and color conversion by using the operation results stored in the internal memory of the system control circuit 50 or in the memory 52 (step S132).

In the development process, the system control circuit 50 also performs a dark correcting operation for canceling the dark current noise of the image sensor 14 and the like by performing subtraction by using the horizontal dark shading correction data rasterized in step S123 or the dark image data loaded in the dark loading process.

When the correcting operation is performed by using the horizontal dark shading correction data as described above, image quality deterioration caused by horizontal dark current noise or fixed-pattern noise produced in the image sensor 14 can be corrected without performing any dark loading for the photographed image. When the correcting operation is performed by using the dark image data loaded in the dark loading process, it is possible to correct that image quality deterioration of the photographed image data, which results not only from horizontal dark current noise or fixed-pattern noise produced in the image sensor 14 but also from two-dimensional factors such as pixel loss caused by a flaw unique to the image sensor 14.

The system control circuit 50 reads out the image data written in the predetermined area of the memory 30, performs image compression corresponding to the set mode by using the compression/expansion circuit 32, and writes the photographed image data subjected to the series of processes in an empty image area of the image storage buffer area of the memory 30 (step S133).

The system control circuit 50 then starts a recording process of reading out the image data stored in the image storage buffer area of the memory 30, and writing the readout image data in the recording media 200 and 210 such as memory cards or compact flash (registered trade mark) cards via the interfaces 90 and 94 and connectors 92 and 96 (step S134). Whenever new photographed image data subjected to the series of processes is written in an empty image portion of the image storage buffer area of the memory 30, this recording starting process is executed for the image data.

While the image data is written in the recording media 200 and 210, the system control circuit 50 performs recording medium write operation indication on the display unit 54, e.g., turns on and off the LED of the display unit 54, in order to indicate that the write operation is being executed.

In addition, the system control circuit 50 checks whether the shutter switch SW1 is pressed (step S135). If the shutter switch SW1 is released, the flow returns to step S102. If the shutter switch SW1 is pressed, the system control circuit 50 checks the state of the single/continuous flag stored in the internal memory of the system control circuit 50 or in the memory 52 (step S136). If single shot is set, the flow returns to step S135, and the current processing is repeated until the shutter switch SW1 is released. If continuous shooting is set, the flow returns to step S124 to prepare for the next photography, in order to continuously perform photography. In this way, the series of processes concerning photography are complete.

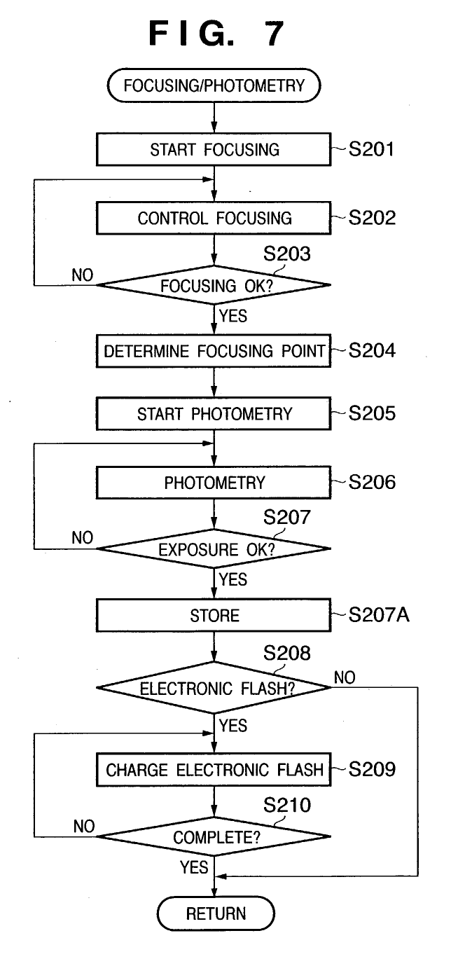

FIG. 7 is a flow chart showing the focusing/photometry procedure in step S114. In this focusing/photometry procedure, various signals are exchanged between the system control circuit 50 and the stop controller 340 or the focusing controller 342 via the interface 120, connectors 122 and 322, interface 320, and lens system control circuit 350.

The system control circuit 50 starts an AF (Auto-Focusing) process by using the image sensor 14 and focusing controllers 42 and 342 (step S201).

The system control circuit 50 feeds light entering the photographing lens 310 to the focusing controller 42 via the stop 312, lens mounts 306 and 106, mirror 130, and focusing submirror (not shown), thereby checking the focusing state of an image formed as an optical image. Until focusing (AF) indicates an in-focus state, the system control circuit 50 detects the focusing state by using the focusing controller 42 while driving the photographing lens 310 by using the focusing controller 342. In this way, the system control circuit 50 executes AF control (steps S202 and S203)

If focusing (AF) indicates an in-focus state in step S203, the system control circuit 50 determines the in-focus focusing point from a plurality of focusing points in the photographing image plane, and stores the determined focusing point data, focusing data and/or set parameters in the internal memory of the system control circuit 50 or in the memory 52 (step S204).

Subsequently, the system control circuit 50 starts an AE (Automatic Exposure) process by using the photometry controller 46 (step S205). The system control circuit 50 feeds light entering the photographing lens 310 to the focusing controller 42 via the stop 312, lens mounts 306 and 106, mirrors 130 and 132, and photometry lens (not shown), thereby checking the exposure state of the image formed as an optical image, and performs photometry by using the exposure (shutter) controller 40 until exposure (AE) is found to be appropriate (steps S206 and S207).

If exposure (AE) is found to be appropriate in step S207, the system control circuit 50 stores the photometry data and/or set parameters in the internal memory of the system control circuit 50 or in the memory 52 (step S207A).

In accordance with the exposure (AE) result detected by the photometry process in step S206 and the photography mode set by the mode dial switch 60, the system control circuit 50 determines an aperture value (Av value) and shutter speed (Tv value).

On the basis of the determined shutter speed (Tv value), the system controller 50 determines the charge storage time of the image sensor 14, and performs photography and dark loading for this determined charge storage time.

On the basis of the photometry data obtained in the photometry process in step S206, the system control circuit 50 checks whether the electronic flash is necessary (step S208). If the electronic flash is necessary, the system control circuit 50 sets a flash flag and charges the electronic flash 48 until it is completely charged (steps S209 and S210). When the electronic flash 48 is completely charged, the system control circuit 50 terminates this processing and returns to the main processing.

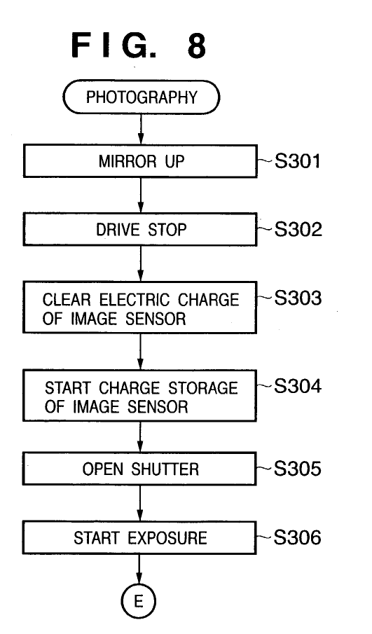

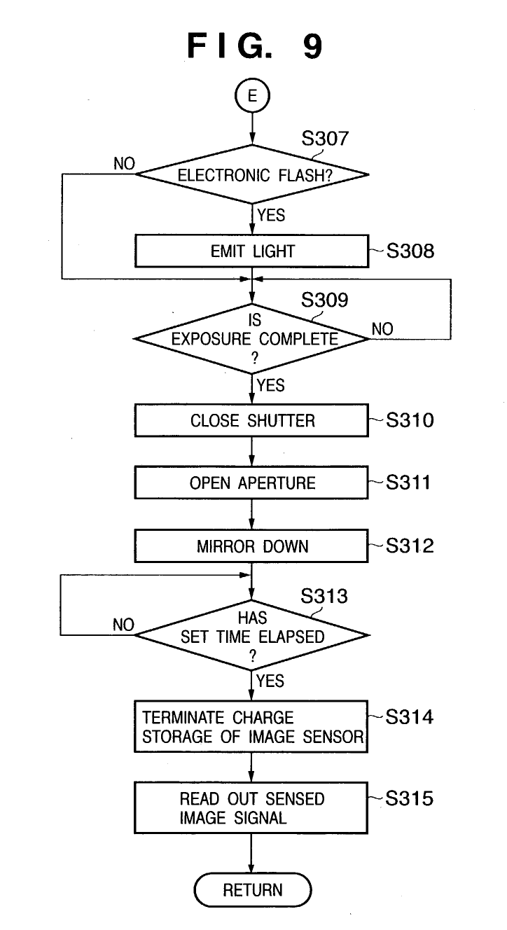

FIGS. 8 and 9 are flow charts showing the photographing procedure in step S128. In this photographing process, various signals are exchanged between the system control circuit 50 and the stop controller 340 or the focusing controller 342 via the interface 120, connectors 122 and 322, interface 320, and lens system control circuit 350.

The system control circuit 50 moves the mirror 130 to a mirror up position by a mirror driver (not shown) (step S301). In accordance with the photometry data stored in the internal memory of the system control circuit 50 or in the memory 52, the system control circuit 50 drives the stop 312 to a predetermined aperture value by the stop controller 340 (step S302).

After clearing the electric charge of the image sensor 14 (step S303), the system control circuit 50 starts charge storage (step S304), opens the shutter 12 by the shutter controller 40 (step S305), and starts exposing the image sensor 14 (step S306).

The system control circuit 50 then checks in accordance with the flash flag whether the electronic flash 48 is necessary (step S307). If YES in step S307, the system control circuit 50 causes the electronic flash 48 to emit light (step S308).

The system control circuit 50 waits for the completion of exposure of the image sensor 14 in accordance with the photometry data (step S309). When the exposure is complete, the system control circuit 50 closes the shutter 12 by the shutter controller 40 (step S310), thereby terminating the exposure of the image sensor 14.

The system control circuit 50 drives the stop 312 to the open aperture value by the stop controller 340 (step S311), and moves the mirror 130 to a mirror down position by the mirror driver (not shown) (step S312).

The system control circuit 50 then checks whether the set charge storage time has elapsed (step S313). If the set charge storage time has elapsed, the system control circuit 50 terminates charge storage of the image sensor 14 (step S314) . After that, the system control circuit 50 reads out an electric charge signal from the image sensor 14, and writes the photographed image data in a predetermined area of the memory 30 via the A/D converter 16, image processing circuit 20, and memory control circuit 22, or from the A/D converter 16 via the memory control circuit 22 alone (step S315). When completing the series of processes, the system control circuit 50 terminates this processing and returns to the main processing.

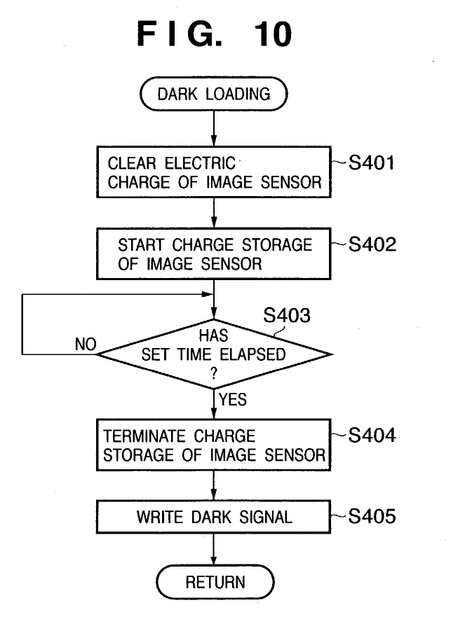

FIG. 10 is a flow chart showing the dark loading process in steps S121 and S131. The system control circuit 50 clears the electric charge of the image sensor 14 (step S401), and starts storing electric charge in the image sensor 14 with the shutter 12 closed (step S402).

The system control circuit 50 then checks whether a preset charge storage time has elapsed (step S403). If this charge storage time has elapsed, the system control circuit 50 terminates the charge storage of the image sensor 14 (step S404), and writes image data (dark image data) in a predetermined area of the memory 30 via the A/D converter 16, image processing circuit 20, and memory control circuit 22, or from the A/D converter 16 via the memory control circuit 22 alone (step S405). This dark image data is used in development performed when photography is executed beforehand and the photographed image data is read out from the image sensor 14 and written in the memory 30.

When development is performed using this dark loading data, image quality deterioration, such as dark current noise produced in the image sensor 14 or pixel loss caused by a flaw unique to the image sensor 14, of photographed image data can be corrected. After that, the system control circuit 50 terminates this processing and returns to the main processing.

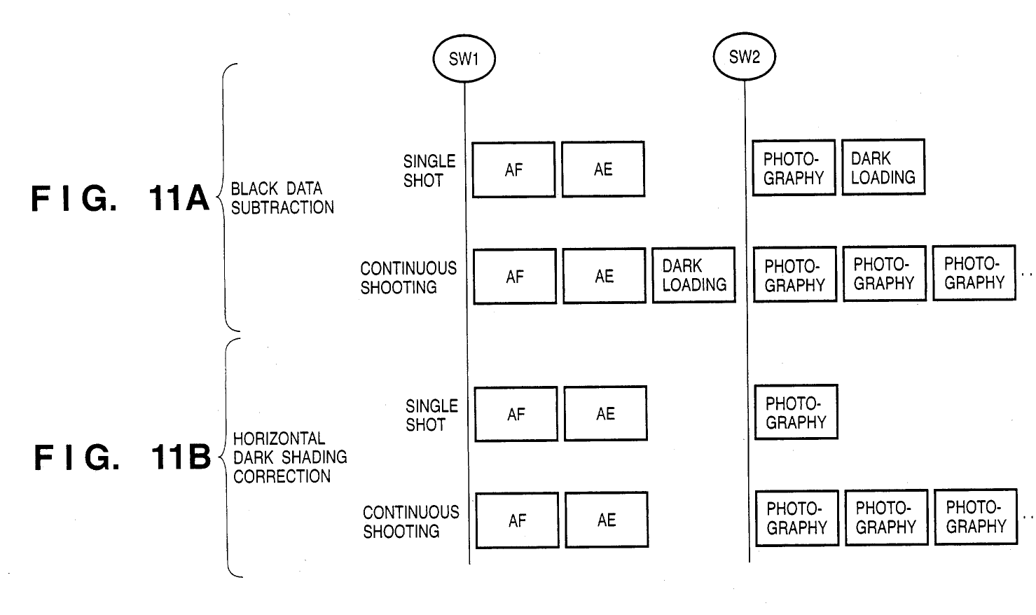

FIGS. 11A and 11B are views showing the flow of photography in this embodiment. As shown in FIG. 11A, if the black data subtraction flag is set in single shot photography, AF (Auto-Focusing) and AE (Automatic Exposure) are performed when the shutter switch SW1 is pressed, and dark loading is performed after photography when the shutter switch SW2 is pressed after that. If the black data subtraction flag is set in continuous photography, dark loading is performed after AF (Auto-Focusing) and AE (Automatic Exposure) when the shutter switch SW1 is pressed, and photography is continuously performed when the shutter switch SW2 is pressed after that.

On the other hand, as shown in FIG. 11B, if the black data subtraction flag is not set and horizontal dark shading correction is to be performed, AF (Auto-Focusing) and AE (Automatic Exposure) are performed when the shutter switch SW1 is pressed, and photography is performed when the shutter switch SW2 is pressed after that, without performing any dark loading, in both single shot photography and continuous photography.

In the image sensing apparatus of this embodiment as described above, when correction is to be performed by selecting prestored horizontal dark shading correction data, no dark image data need be photographed. Therefore, a shutter release time lag can be reduced, and a user does not miss a shutter chance by a release time lag.

Noise which does not change by photographing conditions or environmental conditions, such as fixed-pattern noise equivalent to circuit system noise of an image sensor, can be corrected by prestored correction data. However, noise which changes its amount in accordance with photographing conditions or environmental conditions, i.e., image quality deterioration such as dark current noise produced in an image sensor or pixel loss caused by a very small flaw unique to the image sensor, cannot be completely corrected with prestored data alone in some cases. To correct such noise, if an amount to be corrected is predicted to be largely different from the prestored horizontal dark shading correction data owing to photographing conditions such as the ISO speed or shutter time or environmental conditions such as the ambient temperature, dark loading is performed, and the noise is corrected by using the obtained dark image data. In this manner, deterioration of the image quality can be prevented.

In addition, when an image sensor which requires no correction because its fixed-pattern noise in one of the horizontal and vertical directions is small is to be used, one-dimensional horizontal dark shading correction data, for example, can be used as the prestored correction data. This simplifies the processing and reduces the amount of memory for storing the correction data.

The embodiment of the present invention has been explained above. However, the present invention is not limited to the arrangement of this embodiment and is applicable to any arrangement capable of achieving the functions presented in the scope of claims or the functions of the arrangement of the embodiment.

For example, in the above embodiment, correction data is rasterized in the memory 30 when horizontal dark correction is to be performed. However, correction may also be performed without any rasterization such that correction data is sequentially subtracted from an original image while image data is loaded from the image sensor 14.

Also, in this embodiment, rasterization (S123) of the horizontal dark shading correction data is performed after the shutter switch SW1 is pressed. However, the correction data may also be rasterized when the power supply of the camera is turned on.

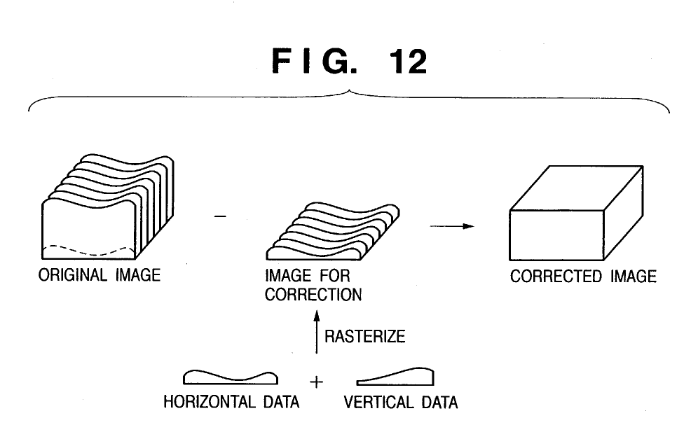

Furthermore, although the correction data is one-dimensional horizontal data in the embodiment, this correction data may also be one-dimensional vertical data or two-dimensional data. Also, the correction data need not be data of a whole two-dimensional image. That is, as shown in FIG. 12, one-dimensional data in both the horizontal and vertical directions are stored. When the one-dimensional horizontal data is to be rasterized in the correction data rasterization process (S123), dark shading in both the horizontal and vertical directions can be corrected by adjusting the correction amount line by line by using the one-dimensional vertical data. FIG. 12 is a view showing original image correction using one-dimensional data in both the vertical and horizontal directions. In this case, the vertical data may also be stored not as one-dimensional correction data but as a mathematical expression. When the one-dimensional horizontal data is to be rasterized, vertical dark shading can be corrected by using this mathematical expression.

In the above embodiment, correction data is formed and stored in the nonvolatile memory 56 during adjustment in the production process. However, this correction data may also be formed and stored by a user at any arbitrary timing by performing a projective arithmetic operation for an image obtained by dark photography.

In the above embodiment, single shot and continuous shooting are switched by using the single/continuous switch 68. However, single shot and continuous shooting may also be switched in accordance with operation mode selection by the mode dial 60.

In the above embodiment, the charge storage time of dark loading is made equal to that of regular photography. However, this charge storage time may also be different provided that data sufficient to correct dark current noise or the like can be obtained.

In the above embodiment, no photography can be performed while dark loading is executed in steps S121 and S131. Therefore, an image or sound indicating that the image processor 100 is in a busy state may be generated by the display unit 54 and/or the image display 28.

In this embodiment, photography is performed by moving the mirror 130 to the mirror up position or mirror down position. However, it is also possible to use a half mirror as the mirror 130 and perform photography without moving the mirror 130.

Furthermore, each of the recording media 200 and 210 need not be a memory card such as a PCMCIA card or compact flash (registered trade mark) card or a hard disk, but may be a micro DAT, a magnetooptical disk, an optical disk such as a CD-R or CD-RW, or a phase changing optical disk such as a DVD. Each of the recording media 200 and 210 may also be a composite medium formed by integrating, e.g., a memory card and hard disk. In this case, a portion may also be detachable from the composite medium.

In the above embodiment, the recording media 200 and 210 are separated from the image processor 100 and can be freely connected. However, one or both of these recording media may also be fixed to the image processor 100. It is also possible to connect one or any arbitrary number of recoding media 200 and 210 to the image processor 100.

Further, the present invention is also applicable to a case in which the invention is achieved by supplying program codes of software for implementing the functions of the above embodiment to a system or apparatus. In this case, the program codes themselves implement the novel functions of the present invention, and the program itself and a storage medium storing the program constitute the invention.

In the above embodiment, program codes shown in the flow charts of FIGS. 3 to 5 and 7 to 10 are stored in the ROM as a storage medium. However, a storage medium for supplying the program codes is not limited to the ROM. For example, it is also possible to use a flexible disk, hard disk, or nonvolatile memory card.

In the present invention, no dark image data need be photographed when correction is to be performed by selecting prestored correction data. Accordingly, a shutter release time lag can be reduced, and a user does not miss a shutter change by a release time lag.

Also, if an amount to be corrected is predicted to be largely different from prestored correction data owing to photographing conditions such as the ISO speed or shutter time or environmental conditions such as the ambient temperature, correction is performed using dark image data obtained in the first image sensing mode. In this manner, deterioration of the image quality can be prevented.

Furthermore, since the prestored correction data is one-dimensional correction data, the processing is simplified, and the amount of memory for storing the correction data is reduced.

As described above, deterioration of the image quality can be prevented while the number of times of dark image photography which causes a shutter release time lag is minimized.

The present invention can be applied to a system constituted by a plurality of devices (e.g., host computer, sensor, interface, reader, printer,) or to an apparatus comprising a single device (e.g., digital camera).

Further, the object of the present invention can also be achieved by providing a storage medium storing program codes for performing the aforesaid processes to a computer system or apparatus (e.g., a personal computer), reading the program codes, by a CPU or MPU of the computer system or apparatus, from the storage medium, then executing the program.

In this case, the program codes read from the storage medium realize the functions according to the described embodiments and the storage medium storing the program codes constitutes the invention.

Further, the storage medium, such as a floppy disk, a hard disk, an optical disk, a magneto-optical disk, CD-ROM, CD-R, a magnetic tape, a non-volatile type memory card, and ROM can be used for providing the program codes.

Furthermore, besides aforesaid functions according to the above described embodiments are realized by executing the program codes which are read by a computer, the present invention includes a case where an OS (operating system) or the like working on the computer performs a part or entire processes in accordance with designations of the program codes and realizes functions according to the above described embodiments.

Furthermore, the present invention also includes a case where, after the program codes read from the storage medium are written in a function expansion card which is inserted into the computer or in a memory provided in a function expansion unit which is connected to the computer, CPU or the like contained in the function expansion card or unit performs a part or entire process in accordance with designations of the program codes and realizes functions of the above described embodiments.

In a case where the present invention is applied to the aforesaid storage medium, the storage medium stores program codes corresponding to the flowcharts described in the embodiments.

The present invention is not limited to the above embodiments and various changes and modifications can be made within the spirit and scope of the present invention. Therefore to apprise the public of the scope of the present invention, the following claims are made.

It is thus believed that the operation and construction of the present invention will be apparent from the foregoing description. While the method, apparatus and system shown and described has been characterized as being preferred, it will be readily apparent that various changes and modifications could be made therein without departing from the scope of the invention as defined in the following claims.

What is claimed is:

1. An image sensing apparatus for recording a photographed image on a recording medium comprising:
image sensing means capable of image sensing in a first image sensing mode in which first image data is obtained by performing image sensing in a non-exposed state, and a second image sensing mode in which second image data is obtained by performing image sensing in an exposed state;
correction data storage means for storing correction data for correcting the second image data obtained in the second image sensing mode, which is obtained by an arithmetic operation on the basis of the first image data;
selecting means for selecting one of the first image data obtained in the first image sensing mode and the stored correction data; and
correcting means for correcting the second image data obtained in the second image sensing mode by using the selected first image data or correction data.

2. The apparatus according to claim 1 wherein the correction data is stored in said correction data storage means in a production process.

3. The apparatus according to claim 1, wherein,
said image sensing means is an image sensor,
the first image data obtained in the first image sensing mode is dark current noise data of said image sensor,
the second image data obtained in the second image sensing mode is photographed image data sensed by said image sensor, and
the correction data is fixed-pattern noise equivalent to circuit system noise of said image sensor.

4. The apparatus according to claim 1, wherein said selecting means performs selection on the basis of photographing conditions and environmental conditions.

5. The apparatus according to claim 4, wherein the photographing conditions include a shutter speed and ISO speed.

6. The apparatus according to claim 4, wherein the environmental conditions include an ambient temperature.

7. The apparatus according to claim 3, wherein the correction data is one-dimensional correction data obtained from the first image data.

8. The apparatus according to claim 7, wherein the one-dimensional correction data is horizontal data obtained by performing a projective arithmetic operation in a vertical direction for image data obtained in the first image sensing mode.

9. An image sensing method of recording a photographed image on a recording medium comprising:
a first image sensing step of obtaining first image data by performing image sensing in a non-exposed state;
a second image sensing step of obtaining second image data by performing image sensing in an exposed state;
a correction data storage step of storing correction data for correcting the second image data, which is obtained by an arithmetic operation on the basis of the first image data;
a selection step of selecting one of the obtained first image data and the stored correction data; and
a correction step of correcting the obtained second image data by using the selected first image data or correction data.

10. The method according to claim 9, wherein the correction data storage step is performed in a production process of an image sensing apparatus.

11. The method according to claim 9, wherein,
the first image data is dark current noise data of an image sensor,
the second image data is photographed image data sensed by the image sensor, and
the correction data is fixed-pattern noise equivalent to circuit system noise of the image sensor.

12. The method according to claim 9, wherein the selection step comprises performing selection on the basis of photographing conditions and environmental conditions.

13. The method according to claim 12, wherein the photographing conditions include a shutter speed and ISO speed.

14. The method according to claim 12, wherein the environmental conditions include an ambient temperature.

15. The method according to claim 11, wherein the correction data is the first image data obtained in the first image sensing mode or data obtained by an arithmetic operation on the basis of the first image data.

16. The method according to claim 15, wherein the correction data is one-dimensional correction data obtained from the first image data.

17. The method according to claim 16, wherein the one-dimensional correction data is horizontal data obtained by performing a projective arithmetic operation in a vertical direction for image data obtained in the first image sensing mode.

18. A storage medium holding a computer-readable program code for implementing the image sensing method cited in any one of claims 9.

19. A program having a computer-readable program code for implementing the image sensing method cited in any one of claims 9.

20. An image sensing apparatus for recording a photographed image on a recording medium comprising:
image sensing means capable of image sensing in a first image sensing mode in which first image data is obtained by performing image sensing in a non-exposed state, and a second image sensing mode in which second image data is obtained by performing image sensing in an exposed state;
correction data storage means for storing correction data for correcting the second image data obtained in the second image sensing mode;
selecting means for selecting one of the first image data obtained in the first image sensing mode and the stored correction data before the image sensing by said image sensing means; and
correcting means for correcting the second image data obtained in the second image sensing mode by using the selected first image data or correction data.
